(19) United States
(12) Patent Application Publication
(10) Pub. No.: US 2009/0056227 A1
(43) Pub. Date: Mar. 5, 2009

(54) Adjustable slide door assembly

(76) Inventor: Ching-Yi Lin, Ho Mei Chen (TW)

Correspondence Address: PHILLIP LIU, 6980, WHITEOAK DR., RICHMOND, BC, V7EAZ9, CA

(21) Appl. No.: 11/892,822

(22) Filed: Aug. 28, 2007

(51) Int. Cl. E06B 3/46

(52) U.S. Cl. 49/209

(57) ABSTRACT

A slide door assembly includes a U-shaped rail box which includes two support plates in a first space so that a roller unit on a slidable door is movably on the support plates. A fixed door has one end engaged with a second space in the rail box and the slidable door is slidable relative to the fixed door. An adjustable part is mounted to one end of the rail box and includes at least one elongate slot, at least one fastening member extends through the at least one elongate slot and is fixed to the rail box so that the adjustable part is movable by releasing the at least one fastening member to fit the distance between two walls.

### FIELD OF THE INVENTION

The present invention relates to an adjustable slide door assembly which includes an adjustable part connected between a wall and the rail box so as to adjust the width of the slidable door.

### BACKGROUND OF THE INVENTION

A conventional slide door assembly generally includes a fixed door and a slidable door which is slidable relative to the fixed door. The slidable door is slid along rails which are defined in rail box. Once the rail box is shorter than the distance between the two walls, there will be a gap between one of the two walls and the slide door assembly. The conventional rail box is usually made by Aluminum so that it cannot be extended and once the rail box is too short, it must be discarded and cannot be used to another place. Besides, a gap is usually found between the fixed door and the slidable door and the gap makes the slidable door shake.

The present invention intends to provide a slidable door assembly and the length of the rail can be adjusted according to needs by using an adjustable member which is connected between one of the two walls and the rail box.

### SUMMARY OF THE INVENTION

The present invention relates to a slide door assembly which comprises a U-shaped rail box having a horizontal potion and two sidewalls extending from two ends of the horizontal portion. A separation plate extends from an inner side of the horizontal portion so as to define a first space and a second space between the two sidewalls. Two support plates extend inward from two respective insides of the two sidewalls such that a roller unit on the slidable door is movable on the support plates. A fixed door is engaged with the second space and the slidable door is slidable relative to the fixed door. An adjustable part is movably mounted to one end of the rail box and at least one elongate slot is defined through the adjustable part. At least one fastening member extends through the at least one elongate slot and is fixed to the rail box.

The primary object of the present invention is to provide a slide door assembly wherein the distance between the wall and an end of the rail box can be adjusted by the adjustable part.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the slide door assembly of the present invention;

FIG. 2 is a perspective view to show the slide door assembly of the present invention;

FIG. 3 is an end cross sectional view taken along line A-B in FIG. 2;

FIG. 4 is an end cross sectional view taken along line C-D in FIG. 2;

FIG. 5A shows that the adjustable part is used to cooperate with the rail box wherein a large gap is defined between the wall and the rail box;

FIG. 5B shows that the adjustable part is used to cooperate with the rail box, wherein a small gap is defined between the wall and the rail box;

FIG. 6 shows the separation piece and the positioning piece are connected to the slidable door and the fixed door;

FIG. 7 shows the slide door assembly including one fixed door and one slidable door;

FIG. 8 shows the slide door assembly including two fixed doors and one slidable door, and

FIG. 9 shows the slide door assembly is used in a bath room.

### DETAILED DESCRIPTION OF THE PREFERRED EMBODIMENT

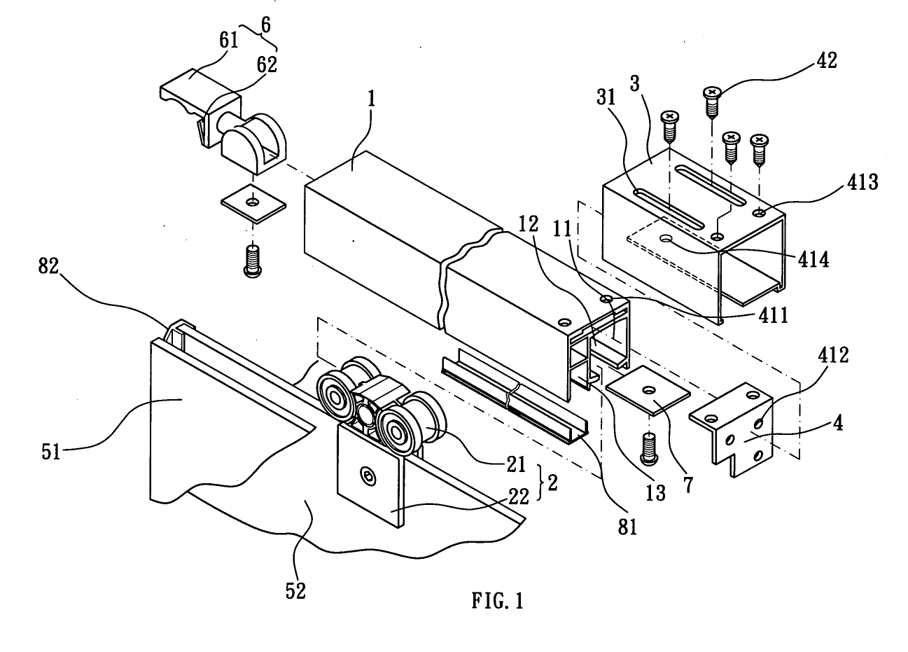

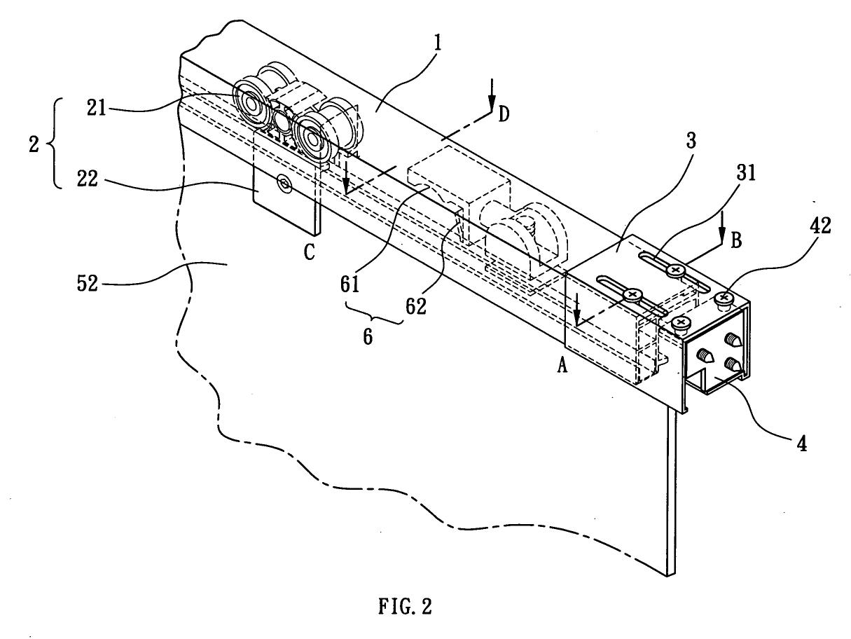

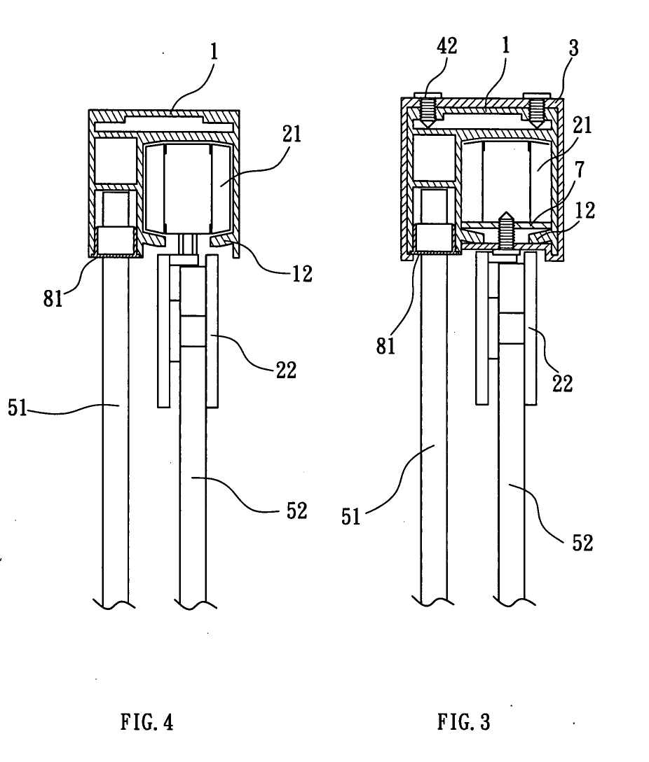

Referring to FIGS. 1 to 4, the slide door assembly of the present invention comprises a U-shaped rail box 1 having a horizontal potion and two sidewalls extending from two ends of the horizontal portion. A separation plate extends from an inner side of the horizontal portion so as to define a first space 11 and a second space 13 between the two sidewalls. Two support plates 12 extend inward from two respective insides of the two sidewalls. Two through holes 411 are defined through the horizontal portion.

An adjustable part 3 is a U-shaped member and movably mounted to one end of the rail box 1. Two elongate slots 31 are defined through a horizontal portion of the adjustable part 3 and two fastening members 42 extend through the elongate slots 31 and are fixed to the rail box 1 such that the adjustable part 3 is movable relative to the rail box 1 by moving the elongate slots 31 relative to the fastening members 42. An end plate 4 is an L-shaped plate which includes a horizontal portion and an upright portion which extends from an end of the horizontal portion. The upright portion includes holes 412 so that screws extend through the holes 412 and fix the end plate 4 to a wall. The horizontal portion includes two holes which are in alignment with the through holes 413 such that fastening members 42 extend through the aligned holes in the horizontal portion of the end plate 4 and the through holes 413 to connect the adjustable part 3 to the end plate 4. The adjustable part 3 includes a reinforcement plate 7 fixedly connected to a horizontal tongue extending from an inside of the adjustable part 3 by a fastening member which extends through the reinforcement plate 7 and a hole 414 in the horizontal tongue.

A fixed door 51 has an end securely engaged with the second space 13 in the rail box 1 and a decoration plate 81 is engaged with the second space 13 that is not occupied by the fixed door 51.

A slidable door 52 has a roller unit 2 connected to an end thereof and the rollers 21 of the roller unit 2 movable on the support plates 12. The roller unit 2 includes a clamp member 22 which includes two side plates between which slidable door 52 is securely clamped. The slidable door 52 is then moved relative to the fixed door 51.

A stop unit 6 is fixed to the support plates 12 in the first space 11 of the rail box 1 and includes a positioning member 61 which includes a horizontal plate and an upright plate. A recess is defined in an underside of the horizontal plate so that a roller of the roller unit 2 can be engaged with the recess to position the slidable door 52. A resilient plate 62 has one end fixed to the upright plate of the stop unit 6 and the other end of the resilient plate 62 is a free end and a gap is defined between the free end and the upright plate. When the slidable door 52 hits the resilient plate 62, the rubber-made stop unit 6 absorbs the vibration so that the noise is reduced. A scrap plate 82 is connected to one side of the slidable door 52 and movably in contact with a surface of the fixed door 51. The scrap plate 82 seals the gap between the fixed door 51 and the slidable door 52.

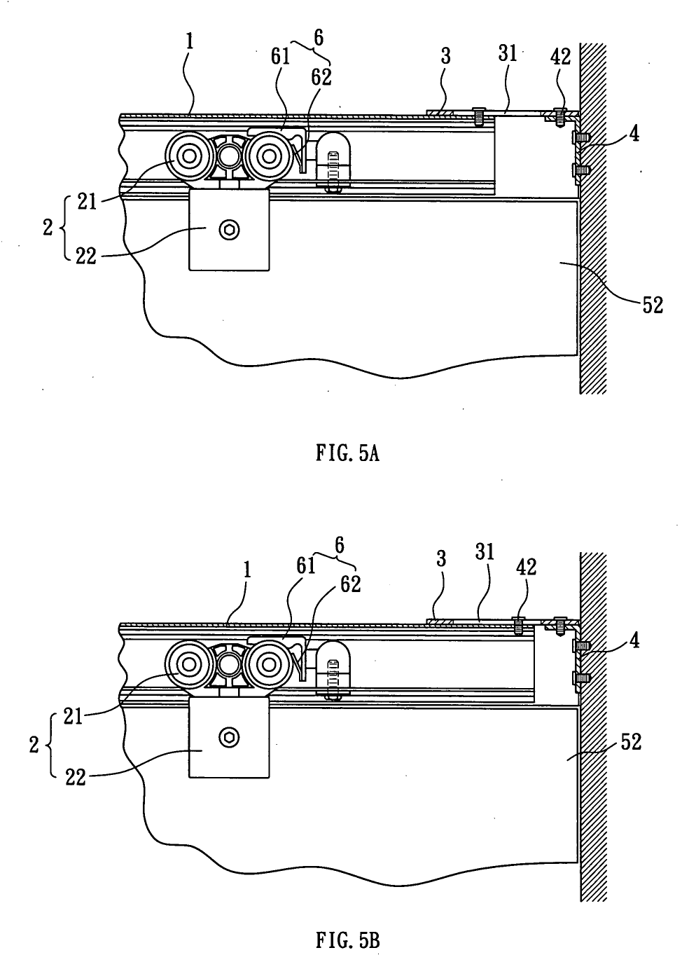

As shown in FIGS. 5A and 5B, when the rail box 1 is too short and a large gap is defined between the wall and the end of the rail box 1, the fastening members 42 can be loosened and moved the rail box 1 away from the wall till the rail box 1 is moved to a desired position, the fastening members 42 are then fastened to set the rail box 1. When the rail box 1 is still a little bit shorter and a small gap is defined between the wall and the end of the rail box 1, the fastening members 42 can be loosened and moved the rail box 1 away from the wall till the rail box 1 is moved to a desired position, the fastening members 42 are then fastened to set the rail box 1. By this way, the shorter rail box 1 can be well connected between two walls.

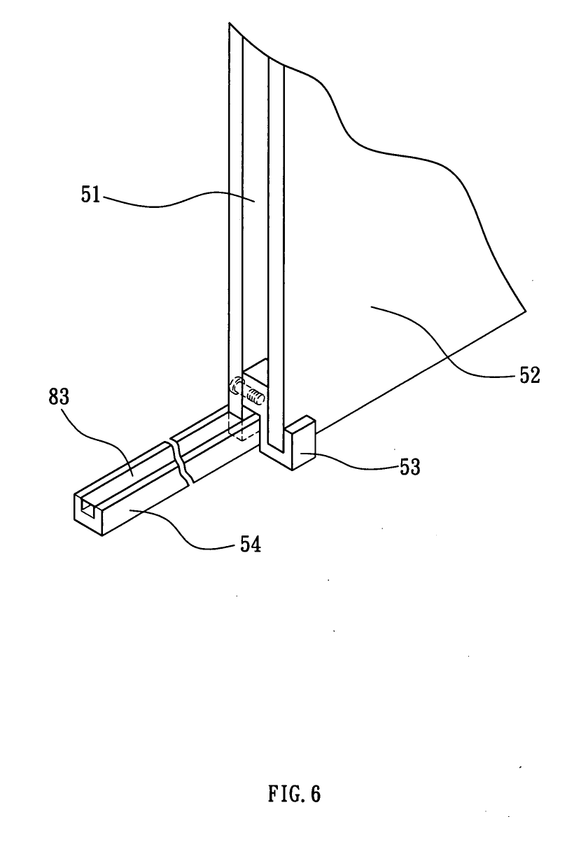

As shown in FIG. 6, a separation piece 53 has one end fixed to the fixed door 51 and the other door includes an engaging recess portion with which the other end of the slidable door 52 is engaged. The separation piece 53 ensures that the fixed door 51 and the slidable door 52 are separated at a fixed distance and this reduces shaking of the slidable door 52. A positioning piece 54 has a groove defined therein and the other end of the fixed door 61 is engaged with the groove to position the fixed door 51. A cover plate 83 is engaged with the groove that is not occupied by the fixed door 51 to prevent dust from entering the groove.

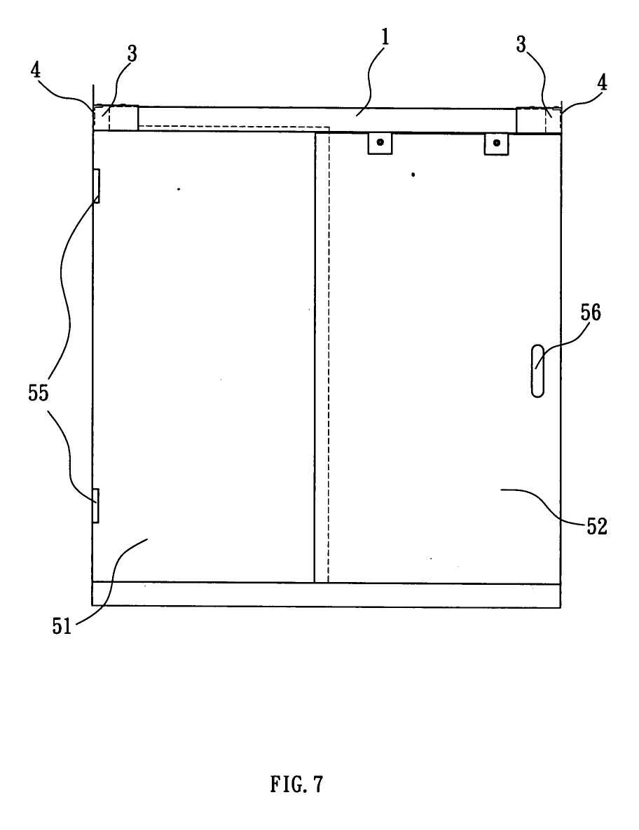

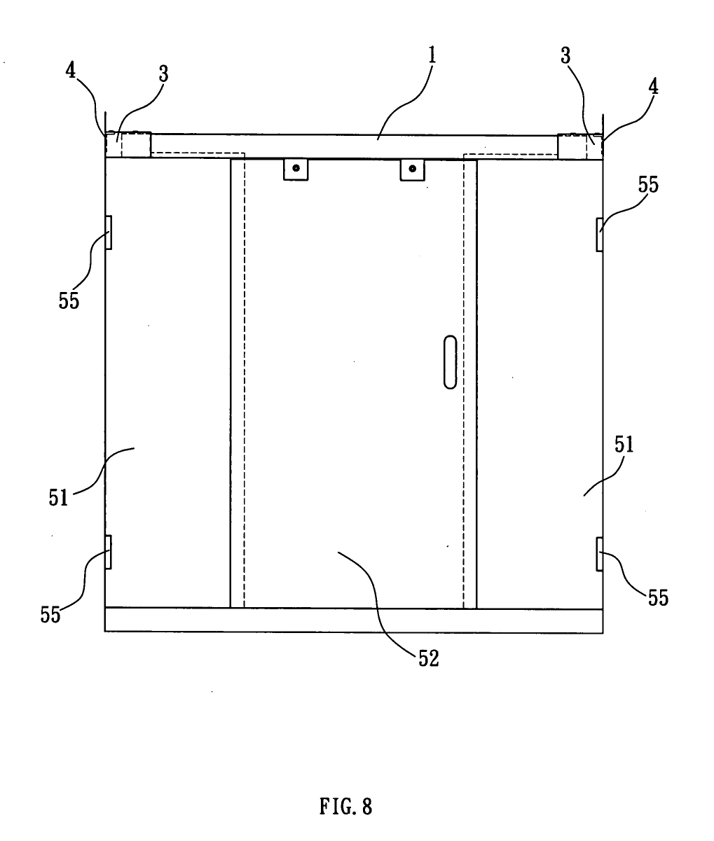

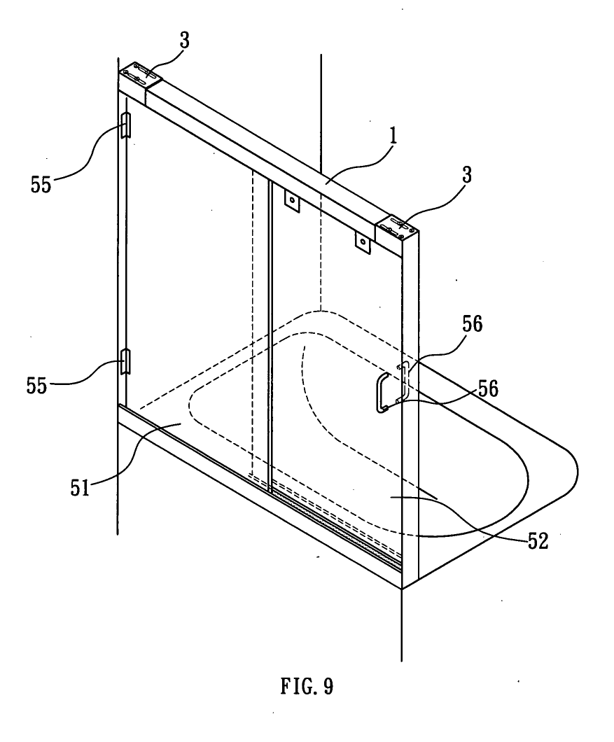

FIG. 7 shows that the slide door assembly includes one fixed door 51 and one slidable door 52, wherein two frames 55 are fixed to a side of the fixed door 51 and a handle 56 is defined in a front surface of the slidable door 52. FIG. 8 shows that the slide door assembly includes two fixed doors 51 and one slidable door 52 is located between the two fixed doors 51. FIG. 9 shows that the slide door assembly is used in a bath room to separate the tub from the rest of the space in the bath room.

While we have shown and described the embodiment in accordance with the present invention, it should be clear to those skilled in the art that further embodiments may be made without departing from the scope of the present invention.

What is claimed is:

1. A slide door assembly comprising:
a U-shaped rail box having a horizontal potion and two sidewalls extending from two ends of the horizontal portion, a separation plate extending from an inner side of the horizontal portion so as to define a first space and a second space between the two sidewalls, two support plates extending inward from two respective insides of the two sidewalls;
an adjustable part being a U-shaped member which is movably mounted to one end of the rail box, at least one elongate slot defined through a horizontal portion of the adjustable part and at least one fastening member extending through the at least one elongate slot and being fixed to the rail box;
a fixed door having an end securely engaged with the second space in the rail box, and
a slidable door having a roller unit connected to an end thereof and the roller unit movable on the support plates.

2. The assembly as claimed in claim 1, wherein the roller unit includes a clamp member which includes two side plates between which slidable door is securely clamped.

3. The assembly as claimed in claim 1, wherein a stop unit is located in the first space of the rail box and includes a positioning member which includes a horizontal plate and an upright plate, a recess is defined in an underside of the horizontal plate so that a roller of the roller unit is engaged with the recess.

4. The assembly as claimed in claim 3, wherein a resilient plate has one end fixed to the upright plate of the stop unit and the other end of the resilient plate is a free end and a gap is defined between the free end and the upright plate.

5. The assembly as claimed in claim 1, wherein an end plate is connected to an end of the adjustable part and adapted to be fixed to a wall.

6. The assembly as claimed in claim 1, wherein a reinforcement plate is fixedly connected to a horizontal tongue extending from an inside of the adjustable part.

7. The assembly as claimed in claim 1, wherein a decoration plate is engaged with the second space that is not occupied by the fixed door.

8. The assembly as claimed in claim 1, wherein a scrap plate is connected to one side of the slidable door and movably in contact with a surface of the fixed door.

9. The assembly as claimed in claim 1, wherein a separation piece has one end fixed to the fixed door and the other door includes an engaging recess portion with which the other end of the slidable door is engaged.

10. The assembly as claimed in claim 1, wherein a positioning piece has a groove defined therein and the other end of the fixed door is engaged with the groove, a cover plate is engaged with the groove that is not occupied by the fixed door.
